(19) United States
(12) Patent Application Publication
(10) Pub. No.: US 2026/0183867 A1
(43) Pub. Date: Jul. 2, 2026

(54) LASER PROCESSING EQUIPMENT AND LASER PROCESSING METHOD

(71) Applicant: AUO Corporation, Hsinchu City (TW)

(72) Inventor: Yu Ting Chen, Hsinchu City (TW)

(73) Assignee: AUO Corporation, Hsinchu City (TW)

(21) Appl. No.: 19/237,017

(22) Filed: Jun. 13, 2025

(30) Foreign Application Priority Data
Dec. 27, 2024 (TW) 113151201

(51) Int. Cl. B23K 26/073

(52) U.S. Cl. CPC B23K 26/073

(57) ABSTRACT

A piece of laser processing equipment includes a first laser light source, a temporary substrate, and a carrier. The first laser light source is configured to provide a first laser line beam. The carrier is configured to carry a processing component. The first laser line beam forms a first laser spot on the carrier, and the processing component is arranged corresponding to a position of the first laser spot. The processing component is located between the temporary substrate and the carrier. A ratio of a length of the first laser spot along a first direction to a width of the first laser spot along a second direction is in a range of 3.3 to 25. Provided is also a laser processing method.

### CROSS-REFERENCE TO RELATED APPLICATION

This application claims the priority benefit of Taiwan application serial no. 113151201, filed on December 27, 2024. The entirety of the above-mentioned patent application is hereby incorporated by reference herein and made a part of this specification.

### BACKGROUND

### TECHNICAL FIELD

The disclosure relates to a piece of laser processing equipment and a laser processing method.

### Related Art

The current laser welding technology mainly uses flux or solder to remove oxide substances on the solder joint, to ensure the stable formation process of intermetallic compound (IMC), so that the component may be successfully welded to the target substrate. However, in laser welding technology, the thermal energy generated by the laser spot may heat the flux or solder, causing phenomenon of intense out-gassing. If bubble entrapment between the target substrate and the component during the pressing process under atmospheric pressure, at the bubble entrapment location, the trapped gas may expand and the component is pushed apart, leading to a failure to mount properly. Therefore, it is very important to effectively reduce the phenomenon of out-gassing caused by laser spot heating.

### SUMMARY

The disclosure provides a piece of laser processing equipment, which may shorten laser spot length, reduce out-gassing volume, and improve laser light usage efficiency, thereby achieving the target of high productivity.

The disclosure provides a laser processing method, which may shorten laser spot length, reduce out-gassing volume, and improve laser light usage efficiency, thereby achieving the target of high productivity.

An embodiment of the disclosure provides a piece of laser processing equipment including a first laser light source, a temporary substrate, and a carrier. The first laser light source is configured to provide a first laser line beam. The carrier is configured to carry a plurality of processing components. The first laser line beam forms a first laser spot on the carrier, and the processing components are arranged corresponding to a position of the first laser spot. The processing components are located between the temporary substrate and the carrier. A ratio of a length of the first laser spot along a first direction to a width of the first laser spot along a second direction is in a range of 3.3 to 25.

An embodiment of the disclosure provides a laser processing method, which includes the following. A first laser light source, a temporary substrate, and a carrier are provided. The first laser light source is configured to provide a first laser line beam. The first laser line beam forms a plurality of first laser spots on the carrier. A plurality of processing components are attached to a surface of the temporary substrate, and the temporary substrate is configured to arrange the processing components corresponding to positions of the first laser spots. The carrier is configured to carry the processing components. A ratio of the laser spots overlapping with each other along a first direction is in a range of 4% to 5%, a ratio of a length of each of the first laser spots along the first direction to a width of each of the first laser spots along a second direction is in a range of 3.3 to 25.

Based on the above, in the laser processing equipment and the method thereof according to the embodiments of the disclosure, the first laser line beam forms the first laser spot on the carrier, and the processing components are arranged corresponding to positions of the first laser spots, a ratio of the first laser spots overlapping with each other along the first direction is in a range of 4% to 5%, a ratio of a length of the first laser spot along the first direction to a width of the first laser spot along the second direction is in a range of 3.3 to 25. In this way, the disclosure may shorten laser spot length, reduce out-gassing volume, and improve laser light usage efficiency, thereby achieving the target of high productivity.

### BRIEF DESCRIPTION OF THE DRAWINGS

FIG. 1A is a schematic diagram of a piece of laser processing equipment according to an embodiment of the disclosure.

FIG. 1B is a top perspective schematic view of a carrier of the piece of laser processing equipment according to an embodiment of the disclosure.

FIG. 2A is a schematic diagram of the piece of laser processing equipment according to an embodiment of the disclosure.

FIG. 2B is a top perspective schematic view of the carrier of the piece of laser processing equipment according to an embodiment of the disclosure.

FIG. 3A is a schematic diagram of the piece of laser processing equipment according to an embodiment of the disclosure.

FIG. 3B is a top perspective schematic view of the carrier of the piece of laser processing equipment according to an embodiment of the disclosure.

### DESCRIPTION OF THE EMBODIMENTS

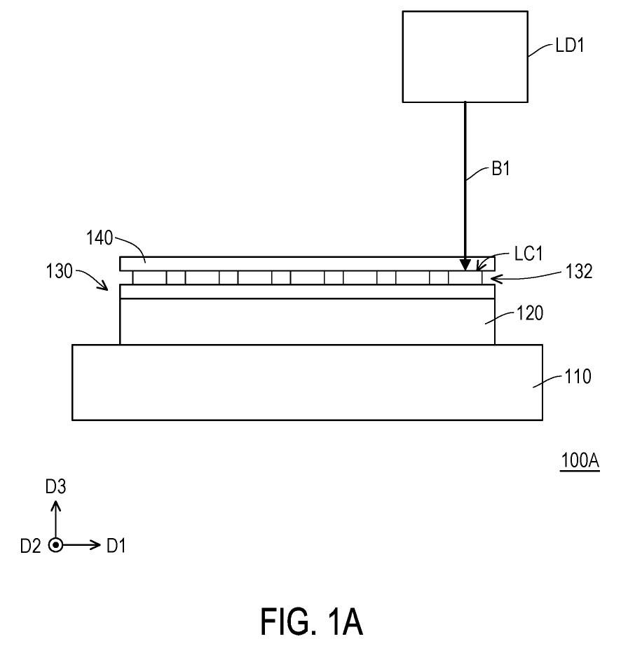

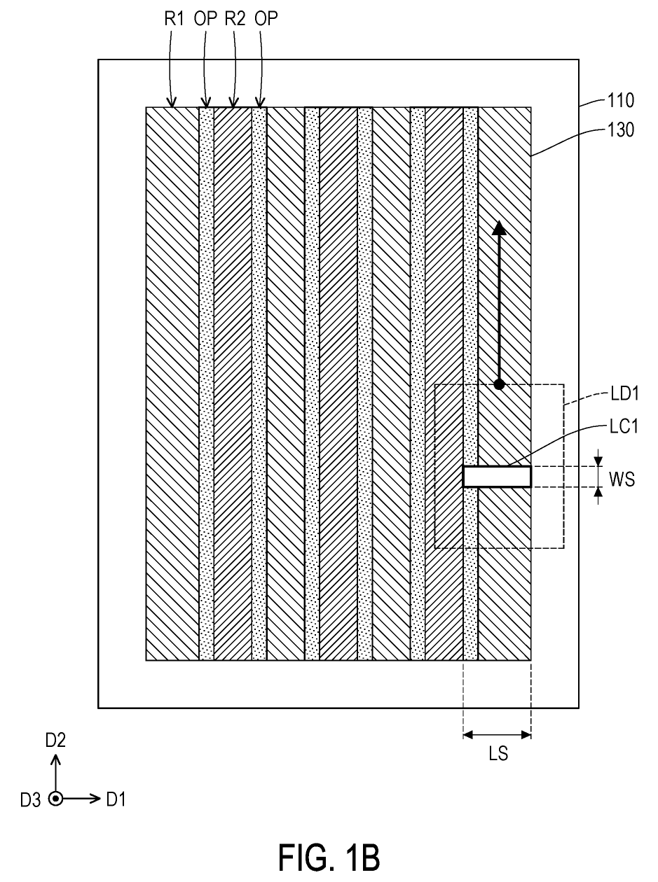

FIG. 1A is a schematic diagram of a piece of laser processing equipment according to an embodiment of the disclosure. FIG. 1B is a top perspective schematic view of a carrier of the piece of laser processing equipment according to an embodiment of the disclosure.

A piece of laser processing equipment 100A includes a first laser light source LD1, a temporary substrate 140, and a carrier 110. The first laser light source LD1 is configured to provide a first laser line beam B1. The carrier 110 is configured to carry a processing component 132. The first laser line beam B1 forms a first laser spot LC1 on the carrier 110. The temporary substrate 140 is configured to attach the processing component 132 on a surface thereof, and then the temporary substrate 140 arranges the processing component 132 attached on the surface thereof corresponding to a position of the first laser spot LC1. A ratio of a length LS of the first laser spot LC1 along a first direction D1 to a width WS of the first laser spot LC1 along a second direction D2 is in a range of 3.3 to 25. The length LS of the first laser spot LC1 along the first direction D1 is in a range of 20 millimeters to 50 millimeters. The width WS of the first laser spot LC1 along the second direction D2 is in a range of 2 millimeters to 6 millimeters.

The material of the carrier 110 and the temporary substrate 140 may be a plate-like object with supporting properties that may reduce bending, wrinkling, and/or deformation of the carrier 110 and the temporary substrate 140. For example, the material of the carrier 110 and the temporary substrate 140 may include glass, quartz, or other suitable materials, or combinations of the above materials, but the disclosure is not limited thereto. The carrier 110 and the temporary substrate 140 may be formed by curing liquid and/or gel initial materials. In some embodiments, the method of forming the carrier 110 and the temporary substrate 140 includes applying liquid and/or gel initial materials on the carrier 110 and the temporary substrate 140, and then using a curing process to cure the liquid and/or gel initial materials to form a flexible carrier 110 and the temporary substrate 140, in which the curing process that may be used includes thermal curing, light curing, or a combination of the above curing processes, but the disclosure is not limited thereto. The material of the carrier 110 and the temporary substrate 140 may include a single-layer structure of one of polyimide (PI), polyethylene terephthalate (PET), or other applicable materials, or a stack or mixture of at least two of the above materials, but the disclosure is not limited thereto.

The laser processing equipment 100A further includes a first substrate 120 and a first film layer 130. The first film layer 130 is disposed on the carrier 110, and the first substrate 120 is located between the carrier 110 and the first film layer 130.

The first substrate 120 may be a circuit board, an active component substrate, or other substrates that may be configured to provide driving signals and/or power to the processing component. When the first substrate 120 is a circuit board, the first substrate 120 may include multiple conductive circuit layers and multiple insulation layers configured to separate the multiple conductive circuit layers, but the disclosure is not limited thereto.

The first film layer 130 may be, for example, a flux film layer. The material of the flux may include, for example, rosin, anti-sagging agent, surfactant, or organic solvent. In some embodiments, the flux may be classified according to physical properties as solid, gel, or liquid. Solid flux is typically encapsulated in solder, and when welding, the solid flux may be configured to remove oxide substances from solder joints on the target substrate. Gel flux may be configured to make solder paste by mixing with tin solder powder, which is applied to the target substrate by spraying, after which components are placed and heated for welding. Liquid flux is mainly used for wave soldering, by uniformly spraying liquid flux on the target substrate to remove oxide substances on the target substrate before welding.

Specifically, the flux mainly helps remove oxide substances between components and solder joints on the target substrate, to increase the connectivity between components and solder joints on the target substrate during welding, thereby improving the yield rate of in-circuit test after welding components with the target substrate. Connectivity may be defined as the contact area between components and solder joints on the target substrate during welding. If the contact area is larger, unreliable solder connection is less likely to occur when components are welded.

In-circuit test measures whether the solder joints and circuits on the target substrate are conductive, mainly testing the quality of the circuit board. The probe is used to contact solder joints, and the probe is used to measure resistance values, if there is no conductivity, then there is a false solder connection between the component and the target substrate. In this case, the in-circuit test fails and the product is determined to be defective. Additionally, if there is too much flux residue on the solder joint preventing the probe from contacting the solder joint, the test also fails, incorrectly identifying the product as defective.

To determine whether unreliable solder connection or insufficient connectivity has occurred between the component and the target substrate, a standard force gauge may be used. When the component push test is 1 gram or less, it is determined to be defective; when the component push test is 2 grams to 3 grams, it is determined to be acceptable. Furthermore, the welding quality between the component and the target substrate is also related to the integrity of the intermetallic compound interface. When the intermetallic compound interface is completely formed, the adhesion strength between the component and the target substrate is also strengthened.

In laser welding technology, the main reason for gas generation on the target substrate is that organic solvents in the flux boil due to heating. If the phenomenon of out-gassing is intense, assuming that bubble entrapment occurs between the target substrate and the component during the pressing process, the cumulative effect of both may cause the phenomenon where the trapped gas may expand and the component is pushed apart and fails to mount properly.

The laser line beam may be defined as having a laser spot length on the carrier 110 falling in a range greater than 20 millimeters and less than 50 millimeters, with a width falling in a range greater than 2 millimeters and less than 6 millimeters. In detail, the power density of the laser light energy and the corresponding laser spot thereof is defined as the ratio of the laser light energy to the laser spot area, that is, power density = power/area. Under the same power density, the laser light energy is proportional to the laser spot area. Therefore, the smaller the laser spot area, the lower the required laser light energy. Choosing a slender laser spot, such as a rectangular laser spot, can thus reduce the laser light energy output. Additionally, the width range of the laser spot is limited by the requirement that stable laser output energy has to be greater than 15% of the total laser output energy. Therefore, in the embodiment of the disclosure, the laser spot length falls in a range greater than 20 millimeters and less than 50 millimeters, with a width falling in a range greater than 2 millimeters and less than 6 millimeters. In this way, the optimal laser light energy may be provided, which can effectively reduce the intense out-gassing caused by the flux receiving excessive heat, alleviating the phenomenon where the trapped gas may expand and the component is pushed apart and fails to mount properly. Meanwhile, the processing component 132 is ensured to have a push test value of 2 grams to 3 grams, which is 200% to 300% higher compared to current laser processing technology.

Referring to FIG. 1B, the first film layer 130 is disposed on the carrier 110. The first film layer 130 includes a first region R1 and an overlapping region OP. A length ratio of the first region R1 to the overlapping region OP along the first direction D1 is in a range of 19 to 24. The first laser line beam B1 emitted from the first laser light source LD1 forms a first laser spot LC1 on the first film layer 130. The first laser spot LC1 may overlap the first region R1 and the overlapping region OP along a third direction D3 of the first substrate 120. The first film layer 130 further includes a second region R2 and two overlapping regions OP. A length ratio of the second region R2 to the two overlapping regions OP along the first direction D1 is in a range of 9 to 11.5. The first laser spot LC1 overlaps the second region R2 and the two overlapping regions OP along the third direction D3 of the first substrate 120. The processing component 132 is arranged corresponding to the position of the first laser spot LC1.

In this embodiment, the length LS of the first laser spot LC1 is reduced by more than 50% compared to the laser spot formed by conventional laser processing equipment, which may significantly lower the gas volume generated by more than 50% during the welding process of the processing component 132 on the first substrate 120. Since the gas volume is reduced by more than 50%, the processing component 132 and the solder joint on the first substrate 120 may be tightly pressed, thereby effectively improving the mounting rate of the processing component 132 on the first substrate 120. At the same time, during the laser processing, due to the reduced gas volume, the overall pressing degree between the processing component 132 and the first substrate 120 can be stably maintained, improving the quality of the interface metallic compound of the processing component 132 on the entire first substrate 120.

It should be noted that the following embodiments use the same reference numerals and partial content as the foregoing embodiments, where similar reference numerals are configured to represent identical or similar components, and explanations of identical technical content are omitted. For explanations of the omitted parts, please refer to the foregoing embodiments. The following embodiments will not repeat these explanations.

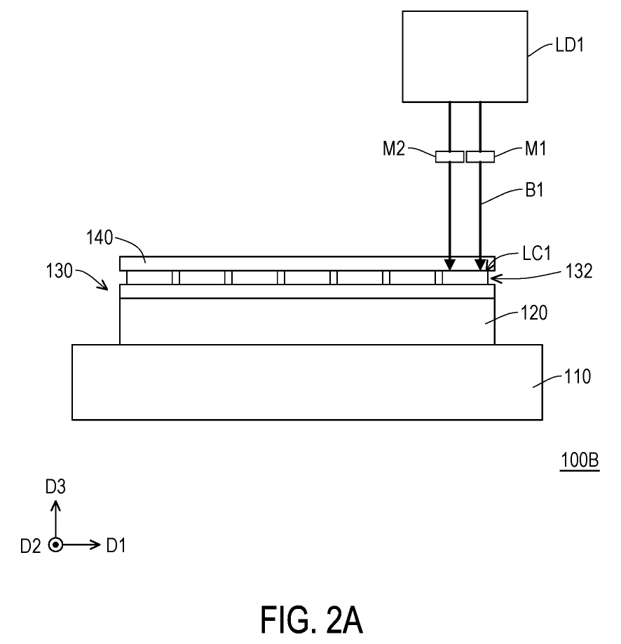

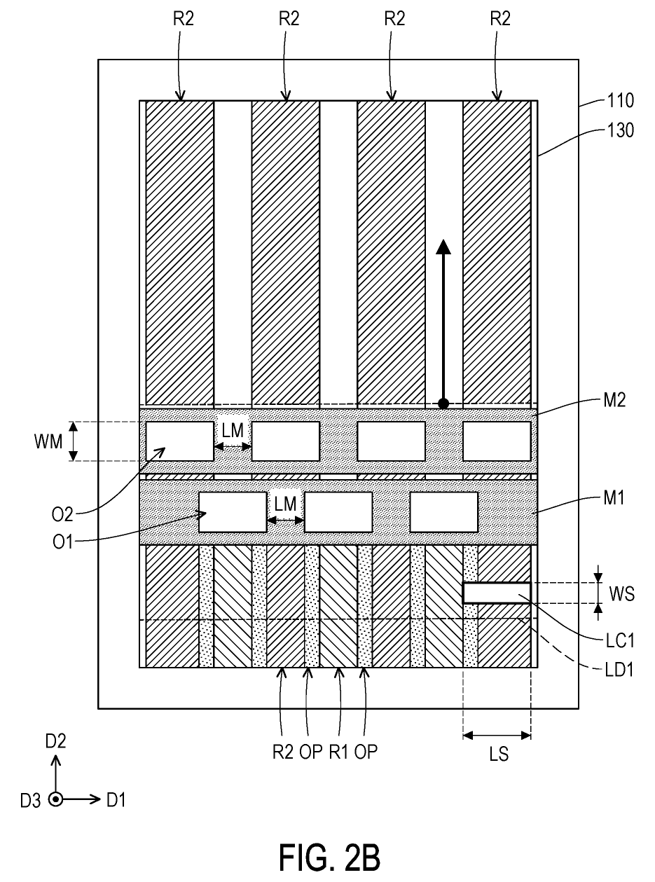

FIG. 2A is a schematic diagram of the piece of laser processing equipment according to an embodiment of the disclosure. FIG. 2B is a top perspective view of the carrier of the piece of laser processing equipment according to an embodiment of the disclosure. Please refer to FIG. 2A and FIG. 2B simultaneously.

A piece of laser processing equipment 100B includes a first laser light source LD1, a temporary substrate 140, a first mask M1, a second mask M2, and a carrier 110. The first laser light source LD1 is configured to provide a first laser line beam B1. The carrier 110 is configured to carry the processing component 132. The first mask M1 and the second mask M2 are disposed between the first laser light source LD1 and the carrier 110. The first laser line beam B1 passes through the first mask M1 and the second mask M2 to form a first laser spot LC1 on the carrier 110. The processing component 132 is arranged corresponding to the position of the first laser spot LC1. The processing component 132 is located between the temporary substrate 140 and the carrier 110. A ratio of the length LS of the first laser spot LC1 along the first direction D1 to the width WS of the first laser spot LC1 along the second direction D2 is in a range of 3.3 to 25.

The first film layer 130 is disposed on the carrier 110. The first mask M1 is disposed corresponding to the first region R1 and two overlapping regions OP on the first film layer 130, and a length ratio of the first region R1 to the two overlapping regions OP along the first direction D1 is in the range of 9 to 11.5. The second mask M2 is disposed corresponding to the second region R2 and the overlapping regions OP on the first film layer 130, and a length ratio of the second region R2 to the overlapping regions OP along the first direction D1 is in the range of 19 to 24. The first mask M1 has a first opening O1, and the first opening O1 is disposed corresponding to the first region R1 and the two overlapping regions OP on the first film layer 130 along the third direction D3. The second mask M2 has a second opening O2, and the second opening O2 is disposed corresponding to the second region R2 and the overlapping regions OP on the first film layer 130 along the third direction D3. The first laser spot LC1 overlaps the first region R1 and the two overlapping regions OP along the third direction D3 of the first substrate 120. The first laser spot LC1 overlaps the second region R2 and the two overlapping regions OP along the third direction D3 of the first substrate 120.

The first laser light source LD1 may move simultaneously with the first mask M1 and the second mask M2 toward one direction (such as the second direction D2). The first opening O1 of the first mask M1 and the second opening O2 of the second mask M2 partially overlap in one direction (such as the second direction D2). When the first laser line beam B1 emitted from the first laser light source LD1 passes through the first mask M1 and the second mask M2, if the length of the first laser line beam B1 is a long-type laser beam greater than 100 millimeters, the partial overlap between the first opening O1 of the first mask M1 and the second opening O2 of the second mask M2 may cause the multiple first laser spots LC1 formed by the first laser line beam B1 passing through the first mask M1 and the second mask M2 and onto the first film layer 130 to have a ratio of overlapping with each other along the first direction D1 falling in a range of 4% to 5%. Furthermore, the length LS of the first laser spot LC1 formed by the first laser line beam B1 on the first film layer 130 may be maintained in a range of 20 millimeters to 50 millimeters.

Therefore, the combination of the first laser light source LD1 with the first mask M1 and the second mask M2 may significantly lower the gas volume generated by more than 50% during the welding process of the processing component 132 on the first substrate 120. Since the gas volume is reduced by more than 50%, the processing component 132 and the solder joint on the first substrate 120 may be tightly pressed, thereby effectively improving the mounting rate of the processing component 132 on the first substrate 120. At the same time, during the laser processing, due to the reduced gas volume, the overall pressing degree between the processing component 132 and the first substrate 120 can be stably maintained, improving the quality of the interface metallic compound of the processing component 132 on the entire first substrate 120. Meanwhile, the processing component 132 is ensured to have a push test value of 2 grams to 3 grams, which is 200% to 300% higher compared to current laser processing technology.

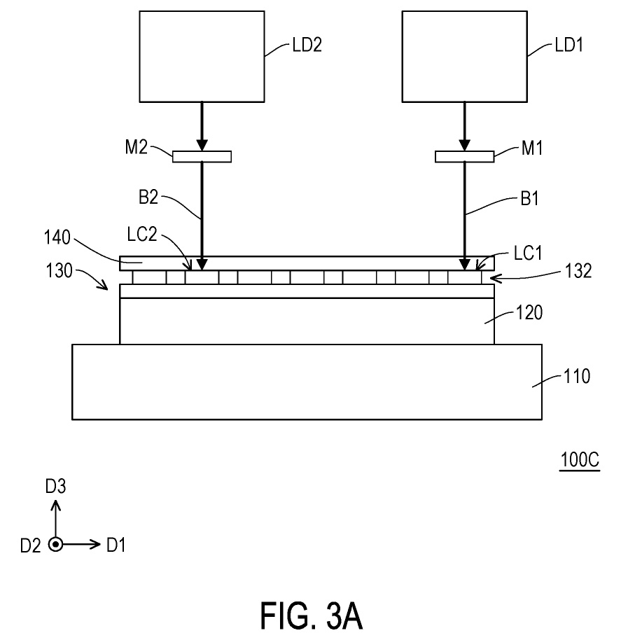

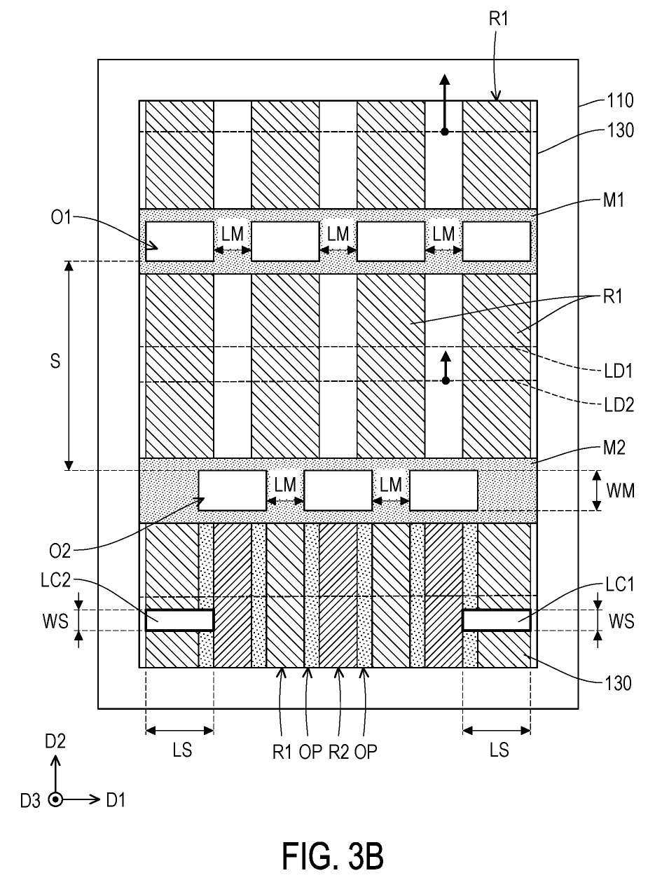

FIG.3A is a schematic diagram of the piece of laser processing equipment according to an embodiment of the disclosure. FIG.3B is a top perspective schematic view of the carrier of the piece of laser processing equipment according to an embodiment of the disclosure. Please refer to FIG.3A and FIG.3B simultaneously.

A piece of laser processing equipment 100C includes a first laser light source LD1, a second laser light source LD2, a temporary substrate 140, a first mask M1, a second mask M2, and a carrier 110. The first laser light source LD1 is configured to provide a first laser line beam B1, and the second laser light source LD2 is configured to provide a second laser line beam B2. The carrier 110 is configured to carry the processing component 132. The first mask M1 is disposed between the first laser light source LD1 and the carrier 110, and the second mask M2 is disposed between the second laser light source LD2 and the carrier 110. The first laser line beam B1 passes through the first mask M1 to form a first laser spot LC1 on the carrier 110, and the second laser line beam B2 passes through the second mask M2 to form a second laser spot LC2 on the carrier 110. The processing component 132 is arranged corresponding to the position of the first laser spot LC1 or the second laser spot LC2. The processing component 132 is located between the temporary substrate 140 and the carrier 110. A ratio of the length LS of the first laser spot LC1 or the second laser spot LC2 along the first direction D1 to the width WS of the first laser spot LC1 or the second laser spot LC2 along the second direction D2 is in a range of 3.3 to 25.

The first film layer 130 is disposed on the carrier 110. The first mask M1 is disposed corresponding to the first region R1 and the overlapping region OP on the first film layer 130, and a length ratio of the first region R1 to the overlapping region OP along the first direction D1 is in the range of 19 to 24. The second mask M2 is disposed corresponding to the second region R2 and two overlapping regions OP on the first film layer 130, and a length ratio of the second region R2 to the two overlapping regions OP along the first direction D1 is in the range of 9 to 11.5.

The first mask M1 has a first opening O1, and the first opening O1 is disposed corresponding to the first region R1 and the overlapping region OP on the first film layer 130 along the third direction D3. The second mask M2 has a second opening O2, and the second opening O2 is disposed corresponding to the second region R2 and two overlapping regions OP on the first film layer 130 along the third direction D3. The first laser spot LC1 overlaps the first region R1 and the overlapping region OP along the third direction D3 of the first substrate 120. The second laser spot LC2 overlaps the second region R2 and the two overlapping regions OP along the third direction D3 of the first substrate 120.

The first laser light source LD1 is used with the first mask M1, and the second laser light source LD2 is used with the second mask M2. The first laser light source LD1 may move simultaneously with the first mask M1 in one direction (such as the second direction D2), and the second laser light source LD2 may move simultaneously with the second mask M2 in one direction (such as the second direction D2). That is, the first laser light source LD1, the first mask M1, the second laser light source LD2, and the second mask M2 may move simultaneously in one direction (such as the second direction D2). If the length of the first laser line beam B1 or the second laser line beam B2 is a long-type laser beam greater than 100 millimeters, the first opening O1 of the first mask M1 and the second opening O2 of the second mask M2 partially overlap in one direction (such as the second direction D2). As a result, when the first laser line beam B1 and the second laser line beam B2 pass through the first mask M1 and the second mask M2, multiple first laser spots LC1 and multiple second laser spots LC2 are formed on the first film layer 130, a ratio of the first laser spots LC1 overlapping with each other along the first direction D1 is in a range of 4% to 5%, or a ratio of the second laser spots LC2 overlapping with each other along the first direction D1 is in a range of 4% to 5%. Furthermore, the length LS of the first laser spot LC1 or the second laser spot LC2 formed on the first film layer 130 may be maintained in a range of 20 millimeters to 50 millimeters.

The first laser spot LC1 may overlap the first region R1 and the overlapping region OP along the third direction D3 on the first substrate 120, and the first laser spot LC1 may overlap the second region R2 and two overlapping regions OP along the third direction D3 on the first substrate 120. The second laser spot LC2 may overlap the first region R1 and the overlapping region OP along the third direction D3 on the first substrate 120, and the second laser spot LC2 may overlap the second region R2 and two overlapping regions OP along the third direction D3 on the first substrate 120. The first mask M1 further includes a first opening O1, and the second mask M2 further includes a second opening O2. A ratio of a spacing S between the first opening O1 and the second opening O2 to the length LS of the first laser spot LC1 or the second laser spot LC2 along the first direction D1 is 1.1, so that the first laser line beam B1 does not overlap with the second laser line beam B2, and provides a sufficiently large heat dissipation interval.

The first opening O1 on the first mask M1 or the second opening O2 on the second mask M2 have a length LM between each other along the first direction D1. A ratio of the length LS of the first laser spot LC1 or the second laser spot LC2 to a length LM between the first opening O1 of the first mask M1 or the second opening O2 of the second mask M2 is 1.05. As a result, a ratio of the multiple first laser spots LC1 formed on the first film layer 130 overlapping with each other along the first direction D1 is in a range of 4% to 5%, or a ratio of the multiple second laser spots LC2 overlapping with each other along the first direction D1 is in a range of 4% to 5%, which may significantly lower the gas volume generated by more than 50% during the welding process of the processing component 132 on the first substrate 120. Since the gas volume is reduced by more than 50%, the processing component 132 and the solder joint on the first substrate 120 may be tightly pressed, thereby effectively improving the mounting rate of the processing component 132 on the first substrate 120. At the same time, during the laser processing, due to the reduced gas volume, the overall pressing degree between the processing component 132 and the first substrate 120 can be stably maintained, improving the quality of the interface metallic compound of the processing component 132 on the entire first substrate 120. Meanwhile, the processing component 132 is ensured to have a push test value of 2 grams to 3 grams, which is 200% to 300% higher compared to current laser processing technology.

The first opening O1 on the first mask M1 or the second opening O2 on the second mask M2 has a width WM along the second direction D2. A ratio of the width WM of the first opening O1 on the first mask M1 or the second opening O2 on the second mask M2 to the width WS of the first laser spot LC1 or the second laser spot LC2 along the second direction D2 is 1.1. In this way, the output width of the first laser line beam B1 or the second laser line beam B2 may be restricted, avoiding unnecessary laser light energy output.

In summary, in the laser processing equipment and the method thereof according to the embodiments of the disclosure, the first laser line beam forms the first laser spot on the carrier, and the processing components are arranged corresponding to positions of the first laser spots, a ratio of the first laser spots overlapping with each other along the first direction is in a range of 4% to 5%, a ratio of a length of the first laser spot along the first direction to a width of the first laser spot along the second direction is in a range of 3.3 to 25. In this way, the disclosure may shorten laser spot length, reduce out-gassing volume, and improve laser light usage efficiency, thereby achieving the target of high productivity.

What is claimed is:

1. A piece of laser processing equipment, comprising:
a first laser light source configured to provide a first laser line beam;
a temporary substrate;
a carrier configured to carry a processing component, wherein the first laser line beam forms a first laser spot on the carrier, the processing component is arranged corresponding to a position of the first laser spot, and the processing component is located between the temporary substrate and the carrier,
wherein a ratio of a length of the first laser spot along a first direction to a width of the first laser spot along a second direction is in a range of 3.3 to 25.

2. The laser processing equipment as claimed in claim 1, wherein the length of the first laser spot along the first direction is in a range of 20 millimeters to 50 millimeters.

3. The laser processing equipment as claimed in claim 1, wherein the width of the first laser spot along the second direction is in a range of 2 millimeters to 6 millimeters.

4. The laser processing equipment as claimed in claim 1, further comprising a first substrate and a first film layer, wherein the first film layer is disposed on the carrier, and the first substrate is located between the carrier and the first film layer.

5. The laser processing equipment as claimed in claim 4, wherein the first film layer comprises a first region and an overlapping region, and a length ratio of the first region to the overlapping region along the first direction is in a range of 19 to 24.

6. The laser processing equipment as claimed in claim 5, wherein the first laser spot overlaps the first region and the overlapping region along a third direction of the first substrate.

7. The laser processing equipment as claimed in claim 4, wherein the first film layer comprises a second region and two overlapping regions, and a length ratio of the second region to the two overlapping regions along the first direction is in a range of 9 to 11.5.

8. The laser processing equipment as claimed in claim 7, wherein the first laser spot overlaps the second region and the two overlapping regions along a third direction of the first substrate.

9. A piece of laser processing equipment, comprising:
a first laser light source configured to provide a first laser line beam;
a temporary substrate;
a first mask;
a second mask; and
a carrier configured to carry a processing component, wherein the first mask and the second mask are disposed between the first laser light source and the carrier, the first laser line beam passes through the first mask and the second mask to form a first laser spot on the carrier, the processing component is arranged corresponding to a position of the first laser spot, and the processing component is located between the temporary substrate and the carrier,
wherein a ratio of a length of the first laser spot along a first direction to a width of the first laser spot along a second direction is in a range of 3.3 to 25.

10. The laser processing equipment as claimed in claim 9, further comprising a first substrate and a first film layer, wherein the first film layer is disposed on the carrier, and the first substrate is located between the carrier and the first film layer.

11. The laser processing equipment as claimed in claim 10, wherein the first laser line beam passes through the first mask, the first mask is disposed corresponding to a first region and two overlapping regions on the first film layer, and a length ratio of the first region to the two overlapping regions along the first direction is in a range of 9 to 11.5.

12. The laser processing equipment as claimed in claim 11, wherein the first laser spot overlaps the first region and the two overlapping regions along a third direction of the first substrate.

13. The laser processing equipment as claimed in claim 10, wherein the first laser line beam passes through the second mask, the second mask is disposed corresponding to a second region and two overlapping regions on the first film layer, and a length ratio of the second region to the two overlapping regions along the first direction is in a range of 19 to 24.

14. The laser processing equipment as claimed in claim 13, wherein the first laser spot overlaps the second region and the two overlapping regions along a third direction of the first substrate.

15. A piece of laser processing equipment, comprising:
a first laser light source configured to provide a first laser line beam;
a second laser light source configured to provide a second laser line beam;
a temporary substrate;
a first mask;
a second mask; and
a carrier configured to carry a processing component, wherein the first mask is disposed between the first laser light source and the carrier, the second mask is disposed between the second laser light source and the carrier, the first laser line beam passes through the first mask to form a first laser spot on the carrier, the second laser line beam passes through the second mask to form a second laser spot on the carrier, the processing component is arranged corresponding to a position of the first laser spot or the second laser spot, and the processing component is located between the temporary substrate and the carrier,
wherein a ratio of a length of the first laser spot or the second laser spot along a first direction to a width of the first laser spot or the second laser spot along a second direction is in a range of 3.3 to 25.

16. The laser processing equipment as claimed in claim 15, further comprising a first substrate and a first film layer, wherein the first film layer is disposed on the carrier, and the first substrate is located between the carrier and the first film layer.

17. The laser processing equipment as claimed in claim 16, wherein the first laser line beam passes through the first mask, the first mask is disposed corresponding to a first region and an overlapping region on the first film layer, and a length ratio of the first region R1 to the overlapping region along the first direction is in a range of 19 to 24.

18. The laser processing equipment as claimed in claim 15, wherein the first laser spot overlaps the first region and the overlapping region along a third direction of the first substrate.

19. The laser processing equipment as claimed in claim 16, wherein the second laser line beam passes through the second mask, the second mask is disposed corresponding to a second region and two overlapping regions on the first film layer, and a length ratio of the second region to the two overlapping regions along the first direction is in a range of 9 to 11.5.

20. The laser processing equipment as claimed in claim 19, wherein the second laser spot overlaps the second region and the two overlapping regions along a third direction of the first substrate.

21. The laser processing equipment as claimed in claim 15, wherein the first mask further comprises a first opening, the second mask further comprises a second opening, and a ratio of a spacing between the first opening and the second opening to a length of the first laser spot or the second laser spot along the first direction is 1.1.
